(19) United States
(12) Patent Application Publication
(10) Pub. No.: US 2026/0310130 A1
(43) Pub. Date: Oct. 8, 2026

(54) A LENS-FREE SINGLE-FRAME PHASE RECOVERY METHOD BASED ON PARTIALLY COHERENT LIGHT-EMITTING DIODE ILLUMINATION

(71) Applicant: Nanjing University of Science and Technology, Nanjing, Jiangsu (CN)

(72) Inventors: Chao Zuo, Nanjing (CN); Qian Chen, Nanjing (CN); Jiasong Sun, Nanjing (CN); Shijie Feng, Nanjing (CN); Yang Chen, Nanjing (CN); Yao Fan, Nanjing (CN); Linpeng Lu, Nanjing (CN); Yuzhen Zhang, Nanjing (CN)

(73) Assignee: Nanjing University of Science and Technology, Nanjing, Jiangsu (CN)

(21) Appl. No.: 19/108,198

(22) PCT Filed: May 5, 2023
(86) PCT No.: PCT/CN2023/092135

§ 371 Date: Mar. 3, 2025

(30) Foreign Application Priority Data
Sep. 13, 2022 (CN) 202211110573.0

(51) Int. Cl. G03H 1/04; H04N 23/56; H04N 23/955

(52) U.S. Cl. CPC G03H 1/0443; H04N 23/56; H04N 23/955; G03H 2210/55; G03H 2222/14; G03H 2222/20; G03H 2225/33

(57) ABSTRACT

A lens-free single-frame phase recovery method based on partially coherent light-emitting diode illumination. The method is implemented in a lens-free on-chip microscopy experiment system. Only a single-color patch LED light source is used for illumination, and a single in-line hologram is collected. High-resolution and high signal-to-noise-ratio phase information of an object is then directly recovered by means of a multi-wavelength iteration phase recovery method in combination with a dynamic phase support constraint. By means of the method, the capability of rapid and long-time lens-free on-chip single-frame phase recovery can be given without the need for complex transformation of a conventional lens-free on-chip microscope. The structure of a microscopy system includes a light source (1), a sample (2) and a sensor (3).

### TECHNICAL FIELD

The present invention is in the domain of optical micrometry and label-free phase recovery technology, specifically pertaining to a lens-free single-frame phase recovery method based on partially coherent light-emitting diode (LED) illumination.

### BACKGROUND

In recent years, there has been increasing demand for high throughput imaging of the subcellular structure in biological samples, especially in the fields of cell biology, digital pathology, and high-throughput drug screening. Limited by the inherent trade-off between objective magnification and field-of-view (FOV), conventional microscopes have difficulty in achieving high-resolution and wide FOV simultaneously. The limitations of the FOV and the resolution can be partially overcome by using the high-precision scanning platform and image stitching algorithm (Brown M, Lowe D G. Automatic panoramic image stitching using invariant features [J]. International journal of computer vision, 2007, 74(1): 59-73). But the system becomes more complex, and the recording and calculating processes become more time-consuming, which is unsuitable for dynamic imaging.

The emergence and rapid development of lens-free on-chip microscopy (LFOCM) in recent years has provided a promising solution to the above problem. In a typical LFOCM system, in-line holograms over the full FOV are recorded for phase reconstruction with all lenses removed and the sample placed close to the sensor. The resolution of a typical LFOCM system is limited by the sampling frequency and coherent diffraction limit. Considering its effective numerical aperture (NA) is close to unity, the pixel-size may be the main factor affecting the imaging resolution. Therefore, in most lens-free imaging systems, it has been demonstrated that small pixel sensors and high coherence laser sources, combined with many pixel super-resolution methods, including sub-pixel lateral translation of image sensors, active parallel plate scanning, sample-to-sensor distances scanning, and multi-wavelength scanning are used to break through the limitation of sampling frequency.

Compared with the laser, partially coherent illumination is particularly useful in the field of optical microscopic imaging, providing a speckle-free image as well as higher throughput. In addition, the light emitting diode (LED) is small and cost-effective, which is conducive to the miniaturization of the lens-free microscope. Therefore, partially coherent LED [14,15] has been used to improve the imaging quality in recent years. Ozcan et al. develop miniaturized lens-free system using LED lighting (Pushkarsky, I., Liu, Y., Weaver, W. et al. Automated single-cell motility analysis on a chip using lens free microscopy. Sci Rep 4, 4717 (2014). https://doi.org/10.1038/srep04717). Zuo et al. Use LED array to achieve mechanical displacement-free experimental systems (Zuo C, Sun J, Zhang J, et al. Lensless phase microscopy and diffraction tomography with multi-angle and multi-wavelength illuminations using a LED matrix [J]. Optics express, 2015, 23(11): 14314-14328.).

Compared to laser, LEDs can improve imaging quality and simplify the entire imaging system with lower coherent noise. However, according to the lens-free imaging resolution theoretical analysis proposed by Zhang et al. (Zhang J, Sun J, Chen Q, et al. Resolution analysis in a lens-free on-chip digital holographic microscope [J]. IEEE Transactions on Computational Imaging, 2020, 6: 697-710), the lack of spatio-temporal coherence of LED causes the diffraction of high-frequency information to mix into the low-frequency regions, replacing the sampling frequency as the main factor limiting the imaging resolution.

To solve the above problems and obtain a higher resolution, some methods have been explored to compensate for the resolution loss caused by the partially coherence of LED. Ozcan et al. used coherent modal decomposition to compensate for the effect of temporal coherence on imaging resolution (Sencan I, Coskun A F, Sikora U, et al. Spectral demultiplexing in holographic and fluorescent on-chip microscopy [J]. Scientific reports, 2014, 4(1): 1-9). Feng et al. on the other hand, utilized an inverse convolution method to compensate for the loss of resolution caused by the lack of spatial coherence (Feng S, Wu J. Resolution enhancement method for lensless in-line holographic microscope with spatially-extended light source [J]. Optics express, 2017, 25(20): 24735-24744). However, they only image sparse samples or simple grating. Therefore, the single-frame phase recovery technology of LFOCM and the long-term dynamic quantitative phase imaging (QPI) observation of biological samples have not been reported so far.

### Content of the Invention

The primary objective of the present invention is to provide a lens-free single-frame phase recovery method that utilizes partially coherent light-emitting diode (LED) illumination. This method is designed to overcome the limitations associated with traditional microscopes and to offer a high-resolution, wide field-of-view imaging solution suitable for dynamic imaging applications in fields such as cell biology, digital pathology, and high-throughput drug screening.

To achieve this objective, the present invention proposes a technical solution in the form of a lens-free single-frame phase recovery method based on partially coherent LED illumination. This method comprises the following steps:
Step 1, recording a hologram of the sample;
Step 2, segmenting the broadband spectrum of the LED based on a spectral prior and initialize phase mask;
Step 3, iteratively updating the object's complex amplitude using digitally segmented sub-wavelengths and the captured hologram to obtain the phase, which specifically includes:
the initial intensity is propagated to the focusing plane to obtain the complex amplitude of the object using the sub-wavelengths of the broad-spectrum LED; a phase support constraint and a uniform light intensity constraint are applied to the phase and amplitude, respectively;
the updated complex amplitude is propagated back to the sensor plane using angular spectrum theory to obtain phase information at the sensor plane based on the current split sub-wavelength; the captured hologram and the spectral priori weighting factor are used to update the amplitude information; this process is iterated over all sub-wavelengths to recover the phase.

Preferably, the method is characterized by the capture of a hologram using a lens-free on-chip microscope system, which comprises a single LED source and a sensor; the LED is a broad-spectrum, non-monochromatic surface-mount LED (SMD) illumination source.

Preferably, the step 2 is specified as follows:
the illumination wavelength λ is divided into N equally spaced quasi-monochromatic wavelength {λ′, i=1, 2, . . . , N} based on the priori of the LED spectrum;
the captured intensity Iᵢₙₜ, generated using the central wavelength λ^{c}, is combined with the initial zero phase ψ₀=0 to initialize the complex amplitude Uₛ⁽⁾=\sqrt{Iᵢₙₜ}·exp(j·ψ₀) at the sensor plane; Uₒⁱ⁺¹ is then back-propagated to the object plane, using the phase part to obtain the initial phase constraint Mask₀.

Preferably, use the captured hologram and the spectral priori weighting factor to update the amplitude information; the specific steps to recover the phase of the object are as follows:
Step 3.1: the complex amplitude at the sensor plane is generated by combining the hologram Iᵢₙₜ with the last splitting subwavelength λⁱ⁻¹;
Step 3.2: the complex amplitude is derived by propagating the complex amplitude to the object plane based on the corresponding wavelength;
Step 3.3: the phase support constraint is applied to the phase component of the complex amplitude at the object plane:

$${φ}_{i}^{′} = ( {φ}_{i} \cdot {Mask}_{i} ) ;$$

updates phase according to wavelength as:

$${φ}_{i + 1} = {φ}_{i}^{′} \cdot {λ}_{i} / {λ}_{i + 1} ;$$

at the same time, the uniform light intensity constraint A₀ⁱ=ave(Aₒⁱ) is applied to the amplitude component to obtain updated complex amplitude Uₒⁱ⁺¹, where ave(·) represents the mean value operator;
Step 3.4: the updated complex amplitude Uₒⁱ⁺¹ is back-propagated to the sensor plane to obtain the phase based on the iₜₕ sub-wavelength λⁱ; repeating step 3.1, the complex amplitude at the sensor plane is updated combining with the weights of the subsequent sub-wavelengths λⁱ⁺¹ until all the split sub-wavelengths been traversed to achieve high resolution and high signal-noise-ratio phase ψ.

Preferably, the generation process of complex amplitude at the sensor plane in step 3.1 is specified:

$${U}_{s}^{i} = {ω}_{i} \cdot \sqrt{{I}_{ini}} \cdot exp ( j \cdot {ψ}_{i} ) ,$$

where Uₛⁱ is the complex amplitude at the sensor plane, ωᵢ is the weighting factor of the iₜₕ sub-wavelength, j is the imaginary unit, and ψᵢ is the phase at the sensor plane according to the last sub-wavelength λⁱ⁻¹.

Preferably, the generated process of complex amplitude at the object plane in step 3.2 is specified as:

$${U}_{o}^{i} = {U}_{s}^{i} \cdot H ( - d ) = {A}_{o}^{i} \cdot exp ( j \cdot {φ}_{i} ) ,$$

where H(−d) is the transform function to propagation distance (−d), Uₒⁱ is the complex amplitude at the object plane, Aₒⁱ is the mode of complex amplitude at the object plane corresponding to the last sub-wavelength λⁱ⁻¹, and φᵢ is the phase at the object plane.

The present invention offers advantages over the prior art: (1) The present invention enables the creation of simplified imaging systems that utilize patch LED illumination, while simultaneously achieving the corresponding resolution results as those obtained using laser illumination. (2) The system requires only one hologram, eliminating the need for a displacement platform and stitching algorithms. This makes the system more compact and cost-effective, enabling real-time, prolonged imaging of live cells under a very large field of view within an incubator.

The present invention is described in further detail below in conjunction with the accompanying drawings.

### ILLUSTRATE WITH DIAGRAMS

FIG. 1 schematically illustrates an experimental setup employing a lens-free single-frame phase recovery method based on partially coherent LED illumination.

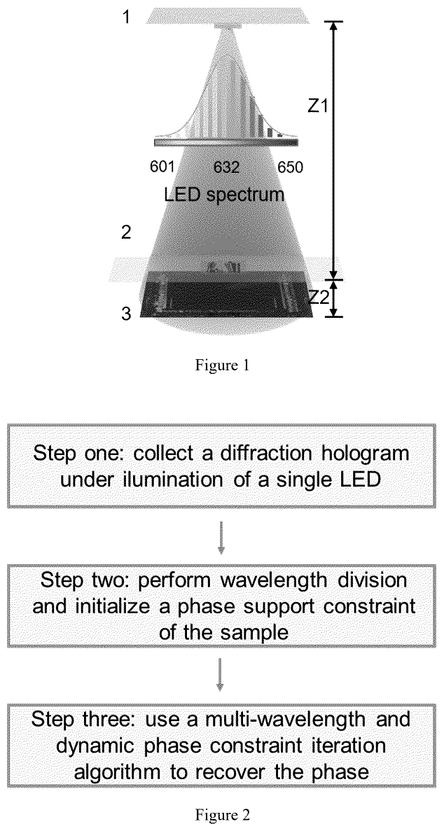

FIG. 2 presents a flowchart depicting the steps of a lens-free single-frame phase recovery method based on partially coherent LED illumination.

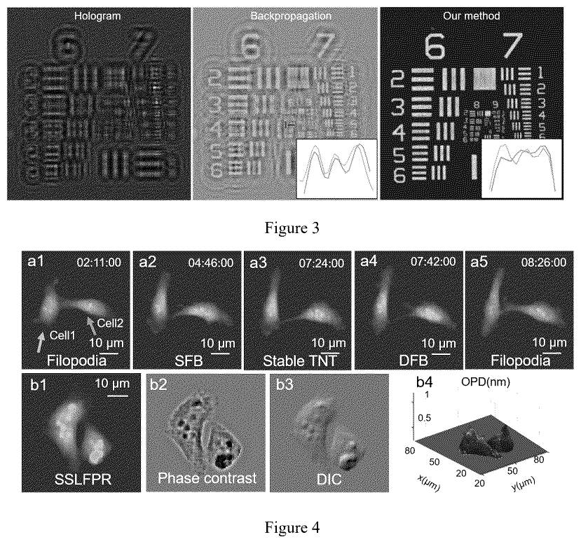

FIG. 3 shows a captured single-frame hologram, a reconstructed phase result using direct back-propagation, and a final reconstructed result of phase resolution target.

FIG. 4 demonstrates the reconstructed long-term live cell phase results and the digitized multimodal results achieved without any use of external equipment, as demonstrated by the present invention.

### SPECIFIC IMPLEMENTATION MODALITIES

As shown in FIG. 2, the lens-free single-frame phase recovery method based on partially coherent light-emitting diode illumination includes the following four steps:

### Step 1: Acquisition of Holograms Using a Lens-Free On-Chip Microscopy System.

As illustrated in FIG. 1, the current invention is based on a conventional lens-free on-chip microscope configuration, comprising solely three components: an illumination source (1), a sample (2), and a sensor (3). The monochromatic SMD LED illumination source (632 nm, bandwidth 23.95 nm, emitting source area 0.0091 mm²) employed in the present invention is utilized for direct illumination of the sample. The spectrum of the source is digitally split into 20 quasi-monochromatic wavelengths at 2-nm intervals for sample reconstruction, with the spectral widths obtained through measurements and experimental validation. The sample was placed directly on the image sensor for imaging, and the system employed a monochromatic CMOS sensor (pixel size 0.9 μm, 5664×4256, Jiangsu Teamone Intelligence Technology Co.).

This is accomplished by employing a broad-spectrum LED incoherent light source to directly illuminate the sample while simultaneously triggering a sensor to record a hologram under the central wavelength illumination.

Step 2: Segmentation of LED broad spectrum based on spectral prior and initialization of phase constraint.

The process is implemented by dividing the illumination wavelength into N equally spaced quasi-monochromatic wavelengths λⁱ, i=1, 2, . . . , N based on the a priori spectrum of the illumination LED.

The captured intensity Iᵢₙₜ, generated using the central wavelength λ^{c}, is combined with the initial zero phase ψ₀=0 to initialize the complex amplitude Uₒ⁽⁾=\sqrt{Iᵢₙₜ}·exp(j·ψ₀) at the sensor plane. Uₛ⁰ is then back-propagated to the object plane, using the phase part to obtain the initial phase constraint Mask₀.

Step 3: Use the captured hologram and the spectral priori weighting factor to update the amplitude information. The specific steps to recover the phase of the object are as follows:

Step 3.1: The generated process of complex amplitude at the sensor plane in step 3.1 is specified:

$${U}_{s}^{i} = {ω}_{i} \cdot \sqrt{{I}_{ini}} \cdot exp ( j \cdot {ψ}_{i} ) ,$$

where Uₒⁱ is the complex amplitude at the sensor plane, ωᵢ is the weighting factor of iₜₕ sub-wavelength, j is the imaginary unit, and ψᵢ is the phase at the sensor plane according to the last sub-wavelength λᵢ₋₁.

Step 3.2: The generated process of complex amplitude at the object plane in step 3.2 is specified:

$${U}_{o}^{i} = {U}_{s}^{i} \cdot H ( - d ) = {A}_{o}^{i} exp ( j \cdot {φ}_{i} ) ,$$

where H(−d) is the transform function to propagation distance (−d), Uₒⁱ is the complex amplitude at the object plane, Aₒⁱ is the mode of complex amplitude at the object plane corresponding to the last sub-wavelength λⁱ⁻¹, and φᵢ is the phase at the object plane.

Step 3.3: The phase support constraint is applied to the phase component of the complex amplitude at the object plane

$${φ}_{i}^{′} = ( {φ}_{i} \cdot {Mask}_{i} ) .$$

Updates phase according to wavelength as:

$${φ}_{i + 1} = {φ}_{i}^{′} \cdot {λ}_{i} / {λ}_{i + 1} .$$

At the same time, the uniform light intensity constraint Aₒⁱ⁺¹=ave(Aₒⁱ) is applied to the amplitude component to obtain updated complex amplitude Uₒⁱ⁺¹, where ave(·) represents the mean value operator.

Step 3.4: The updated complex amplitude Uₒⁱ⁺¹ is back-propagated to the sensor plane to obtain the phase based on the iₜₕ sub-wavelength λⁱ. Repeated in step 3.1, the complex amplitude at the sensor plane is updated combining with the weights of the subsequent sub-wavelengths λⁱ⁺¹ until all the split sub-wavelengths been traversed to achieve high resolution and high signal-noise-ratio phase ψ.

FIG. 3 illustrates the captured hologram and compares the resolution of the conventional single-frame LED method, which is 1.381 μm, with the present invention, demonstrating a 1.41-fold resolution enhancement, achieving 0.977 μm. FIG. 4 presents the dynamic results of live cells in long-term culture, reconstructed using the present invention. The figures display phase contrast, differential proportionality, and 3D structural images, all of which were reconstructed by digital methods.

The present invention employs a SMD broad-spectrum LED illumination source to obtain an in-line hologram under vertical illumination. By integrating propagation models and incoherent superposition models, the amplitude is continuously propagated and updated. Subsequently, a multi-wavelength-based phase recovery reconstruction algorithm, coupled with a dynamic phase-support constraint method, is utilized to recover the phase of the sample. This invention features a single patch LED source and eliminates the need for any mechanical displacement, thereby enhancing the system's stability and reducing costs.

1. A lens-free single-frame phase recovery method based on partially coherent light-emitting diode illumination, comprising the steps of:
Step 1, recording a hologram of the sample;
Step 2, segmenting the broadband spectrum of the LED based on spectral prior knowledge and initializing a phase mask;
Step 3, iteratively updating the complex amplitude of the object and obtaining phase information using digitally segmented sub-wavelengths from the captured hologram, which specifically includes:
propagating the initial intensity to the focusing plane to determine the complex amplitude of the object using the sub-wavelength components of the broad-spectrum LED; applying phase support constraints and uniform light intensity constraints to the phase and amplitude, respectively;
propagating the updated complex amplitude back to the sensor plane through angular spectrum projection to achieve the phase information at the sensor plane based on the current sub-wavelength segment, utilizing the captured hologram and the spectral priori weighting factor to refine the amplitude information; iterating through all sub-wavelengths to recover the phase.

2. According to claim 1, the invention comprises a lens-free single-frame phase recovery method based on partially coherent light-emitting diode illumination; the method is characterized by the capture of a hologram using a lens-free on-chip microscope system, which comprises a single LED source and a CMOS sensor; the employed source is a broad-spectrum, non-monochromatic surface-mount LED.

3. According to claim 1, the invention comprises a lens-free single-frame phase recovery method based on partially coherent light-emitting diode illumination; Step 2 of the method is detailed as follows:
the illumination wavelength λ is segmented into N equally spaced quasi-monochromatic wavelengths {λ′, i=1, 2, . . . , N} based on the priori of the LED spectrum;
the captured intensity Iᵢₙₜ, generated using the central wavelength λ^{c}, is combined with the initial zero phase ψ₀=0 to initialize the complex amplitude Uₛ⁽⁾=\sqrt{Iᵢₙₜ}·exp(j·ψ₀) at the sensor plane; Uₛ⁰ is then back-propagated to the object plane, using the phase part to obtain the initial phase constraint Mask₀.

4. According to claim 1, the invention comprises a lens-free single-frame phase recovery method based on partially coherent light-emitting diode illumination; the method utilizes the captured hologram in conjunction with a spectral priori weighting factor to refine the amplitude information; the detailed steps for recovering the phase of the object are outlined below:
Step3.1: the complex amplitude at the sensor plane is generated by integrating the hologram Iᵢₙₜ with the last splitting subwavelength λⁱ⁻¹;
Step 3.2: the complex amplitude is derived by propagating the complex amplitude to the object plane based on the corresponding wavelength;
Step 3.3: the phase support constraint is applied to the phase component of the complex amplitude at the object plane:
$${φ}_{i}^{′} = ( {φ}_{i} \cdot {Mask}_{i} ) ;$$
the phase is updated according to the wavelength as follows:
$${φ}_{i + 1} = {φ}_{i}^{′} \cdot {λ}_{i} / {λ}_{i + 1} ;$$
at the same time, the uniform light intensity constraint Aₒⁱ⁺¹=ave(Aₒⁱ) is applied to the amplitude component to obtain updated complex amplitude Uₒⁱ⁺¹, where ave(·) represents the mean value operator;
Step 3.4: the updated complex amplitude Uₒⁱ⁺¹ is back-propagated to the sensor plane to obtain the phase based on the iₜₕ sub-wavelength λⁱ; repeating step 3.1, the complex amplitude at the sensor plane is updated by combining it with the weights of the subsequent sub-wavelengths λⁱ⁺¹ until allsplit sub-wavelengths have been traversed to achieve high resolution and high signal-noise-ratio phase ψ.

5. According to claim 4, the invention comprises a lens-free single-frame phase recovery method based on partially coherent light-emitting diode illumination; the process for generating the complex amplitude at the sensor plane in step 3.1 is specified as follows:
$${U}_{s}^{i} = {ω}_{i} \cdot \sqrt{{I}_{ini}} \cdot exp ( j \cdot {ψ}_{i} ) ,$$
where Uₛⁱ is the complex amplitude at the sensor plane, ωᵢ is the weighting factor of the iₜₕ sub-wavelength, j is the imaginary unit, and ψᵢ is the phase at the sensor plane according to the last sub-wavelength λⁱ⁻¹.

6. According to claim 4, the invention comprises a lens-free single-frame phase recovery method based on partially coherent light-emitting diode illumination; the process for generating the complex amplitude at the object plane in step 3.2 is specified as follows:
$${U}_{o}^{i} = {U}_{s}^{i} \cdot H ( - d ) = {A}_{o}^{i} exp ( j \cdot {φ}_{i} ) ,$$
where H(−d) is the transform function to propagation distance (−d), Uₒⁱ is the complex amplitude at the object plane, Aₒⁱ is the mode of complex amplitude at the object plane corresponding to the last sub-wavelength λⁱ⁻¹, and φᵢ is the phase at the object plane.
